(19) United States
(12) Patent Application Publication
(10) Pub. No.: US 2009/0224690 A1
(43) Pub. Date: Sep. 10, 2009

(54) ECONOMY MODE FOR LIGHTING CONTROL SYSTEM

(76) Inventors: Jian Xu, Windsor (CA); Jeffrey Iott, Monroe, MI (US)

Correspondence Address: Masco Corporation, 21001 Van Born Road, Taylor, MI, 48480, US

(21) Appl. No.: 12/398,218

(22) Filed: Mar. 5, 2009

Related U.S. Application Data
(60) Provisional application No. 61/033,900, filed on Mar. 5, 2008.
(60) Provisional application No. 61/078,468, filed on Jul. 7, 2008.

(51) Int. Cl. H05B 37/02

(52) U.S. Cl. 315/292

(57) ABSTRACT

A lighting control system determines a lumen output of a lighting load and selectively reduces power of that load until the power provided is the least power that can be provided to approximate the stated lumen output of that load. The system further includes a receiver/controller (“RC”) operable to selectively power a dimmable load and an eco-mode button operable to command the RC to reduce a luminance of the dimmable load by predetermined amounts such that the reduction in power reduces the luminance of the dimmable load but is visibly undetectable by a majority of viewers. The predetermined amount is within a range of 80-99% of the first luminance. The button is also operable to command the RC to revert to the first luminance.

This application claims priority to U.S. Provisional Application No. 61/033,900 which was filed on Mar. 5, 2008 and U.S. Provisional Application No. 61/078,468 which was filed on Jul. 7, 2008.

### BACKGROUND OF THE INVENTION

This application relates to lighting control systems.

If power to a lighting load is reduced, a level of brightness may also be reduced. However, a human eye may not perceive that the level of brightness has actually been reduced.

### SUMMARY OF THE INVENTION

A lighting control system determines a lumen output of a lighting load and selectively reduces power of that load until the power provided is the least power that can be provided to approximate the stated lumen output of that load.

According to a further aspect of the invention, the lighting control system includes a receiver/controller (“RC”) operable to selectively control a dimmable load and a eco-mode button operable to command the RC to reduce a luminance of the dimmable load by a predetermined amount such that the reduction in power consumption reduces the luminance of the dimmable load but is visibly undetectable by a majority of viewers. The predetermined amount is within a range of 1-20% of the first luminance. The button is also operable to command the RC to revert to the first luminance.

These and other features of the present invention can be best understood from the following specification and drawings, the following of which is a brief description.

### BRIEF DESCRIPTION OF THE DRAWINGS

FIG. 1 schematically illustrates an example wireless battery-less lighting control application.

FIG. 2 illustrates a prior art representation of a percentage of reduction in luminance compared to a percentage of people who detected the reduction in luminance.

FIG. 3a illustrates a control to power a load to provide a desired lumen output.

FIG. 3b illustrates a control including a lumen sensor to power a load to provide a desired lumen output.

### DETAILED DESCRIPTION OF THE PREFERRED EMBODIMENT

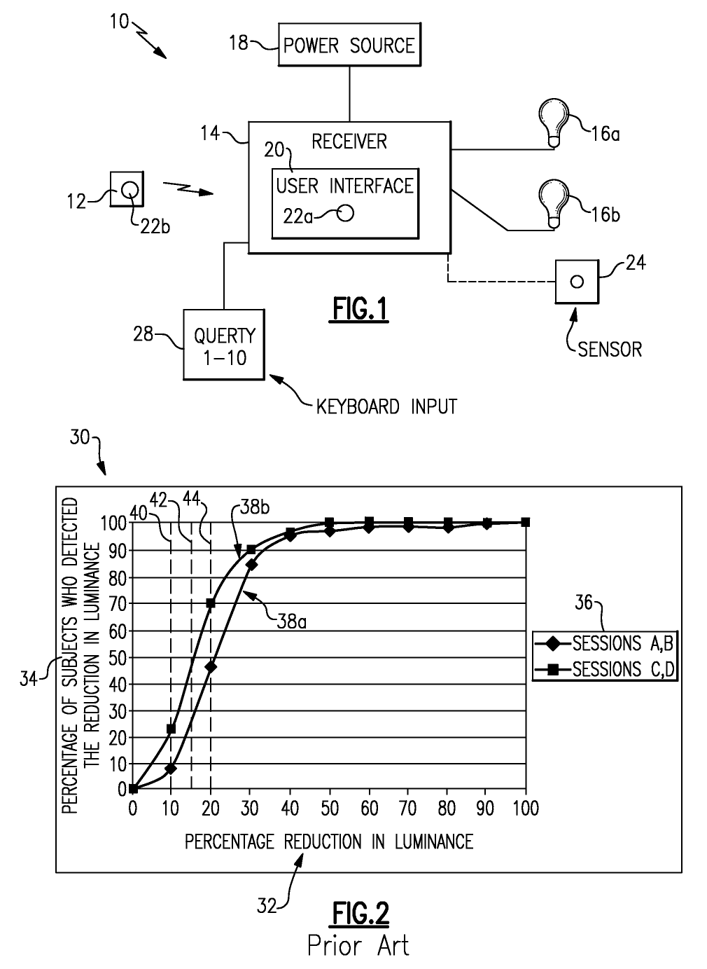

FIG. 1 schematically illustrates an example wireless battery-less lighting control application 10. A wireless battery-less switch 12 transmits a signal to a receiver/controller (“RC”) 14. The RC 14 selectively provides power to a load 16A, 16B from a power source 18. The load 16a is coupled to a first channel of the RC 14, and the load 16b is coupled to a second channel of the RC 14. Although the example RC 14 is a multi-channel RC, it is understood that a RC could be a single channel RC and could be coupled to more or less than two items. One wireless battery-less switch is available from Liberty Hardware under Product No. X3100 or X3200, and one RC is available from Liberty Hardware under Product No. X2110, however it is understood that this specific switch and RC would not need to be used.

Referring again to FIG. 1, a lumen sensor 24, such as lumen sensor part no. X4100 provided by the Liberty Hardware Company is provided near a lighting load. The sensor can be fixed in place for continuous use or be portable to enable a user to use the sensor at different times as, for instance, when a bulb is replaced. The lumen sensor may be wireless battery-less and powered by solar cell that is powered by the lighting loads themselves or may be hardwired into an electrical system (not shown).

Some lighting 16 and other (not shown) loads are oversaturated with power at their rated output. In other words, power directed to the lighting load is more than the loads needs to operate at the required or rated output. Additional power is redundant as it does not generally produce more lumens. The additional power may however, produce more heat and limit the life of the lighting load. Significant cost savings can be accrued if the over-saturating power, e.g., that point where power exceed that which is just necessary to provide the stated output, is controlled and eliminated. Upon turning on a lighting load, such as a 600 lumen LED or the like, the system measures the lumens and communicates to the RC 14 that the LED is at or near 600 lumens. The RC then ramps down the over-saturating power to the load while continually receiving status information from the sensor 24. At the point where the LED drops in a significant way (as will be described herein) if the load is dimmable or simply at or slightly below the 600 lumens, the RC stops ramping the power down. The RC then, if the load is dimmable, ramps the power back up to just above the significant drop or simply back to 600 lumens if the load is not dimmable and if the power ramped down enough to lower the lumens below 600 lumens.

If the lighting load has a known output, for instance, the lumen output for a bulb is 700 lumens and the bulb is measured to be displaying more than 700 lumens by the sensor 24 then the RC simply directs the lighting load to produce 700 lumens or to a point where a drop is not significant if the load is dimmable as will be discussed herein.

FIG. 2 illustrates a graph 30 displaying a percentage of reduction in luminance 32 compared to a percentage of people who detected the reduction in luminance 34. FIG. 2 was originally published in August 2004 in the article “Linear Fluorescent Dimming Ballasts: Technology, Methods, Protocols” written by Craig DiLouie, and available on the Lighting Controls Association website (www.aboutlightingcontrols.org). As shown in legend 36, there were several sessions conducted, represented by lines 38a and 38b. The data shows that at a 10% reduction in luminance (see line 40), approximately 90% of the subjects did not notice a reduction in luminance. At a 15% reduction in luminance (see line 42), approximately 75% of the subjects did not notice a reduction in luminance. At a 20% reduction in luminance (see line 44), approximately 55% of the subjects did not notice a reduction in luminance.

A known relationship between measured light level and perceived brightness may be represented by equation #1, shown below, which yields a “square law” curve, as illustrated by lines 38a and 38b.

$$PerceivedLight ( \% ) = 100 \times \sqrt{( \frac{MeasuredLight ( \% )}{100} )} \qquad equation \#1$$

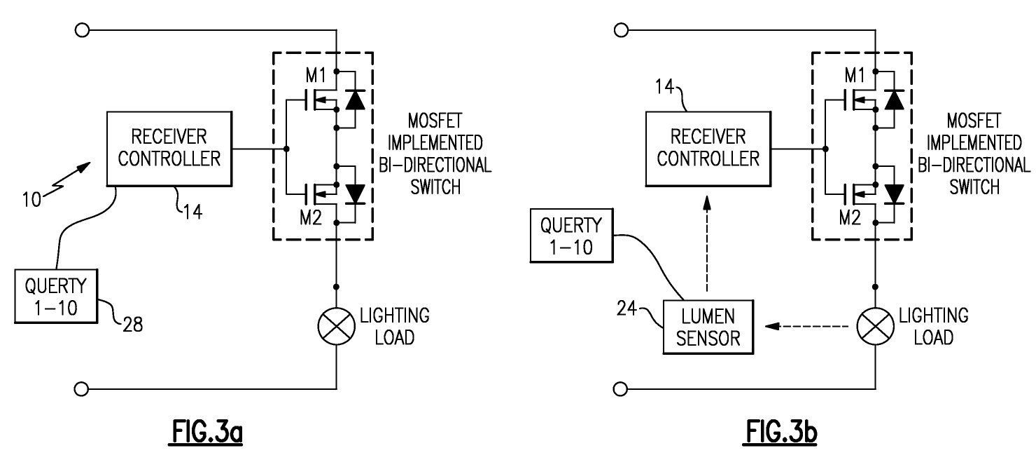

Referring to FIGS. 1 and 3, the RC includes a user interface 20 having an “eco-mode” button 22a or 22b corresponding to an economy mode. When button 22a is pressed, the RC 14 enters an economy mode in which a brightness of every dimmable lighting load 16 is reduced by a first predetermined amount according to the square law curve of FIG. 2. The first predetermined amount is a 1%-20% reduction in lumens. Use of the eco-mode button preserves energy while preventing a user from detecting a reduction in brightness. The RC may be instructed by the eco-mode button 22b in the switch 12 which then reduces a brightness of all dimmable lights associated with the switch 12. In another example, the predetermined amount is within a range of 5-15%. Activation of either eco-mode button preserves energy while minimizing the probability that a user detects a reduction in brightness. The eco-mode buttons 22a, 22b are operable to command the RC 14 to revert back to the first luminance by pressing the buttons a second time. Another methodology includes multiple presses of either button to vary the degree of dimming, e.g. one press dims the lighting load(s) to the first predetermined level, two presses dims the lighting load(s) to a second predetermined level and three pushes or taps turns off the eco-mode to return to the original lighting level. One of ordinary skill in the recognizes that other button press patterns may be implemented hereunder to achieve the goals stated herein.

The eco-mode provided by the system has two levels of control. Level 1, as will be discussed hereinbelow, reduces the input power of a lighting load from its given or normal lumen output while fully on, to a power level where the lumen output of the lighting load starts to change/drop, e.g., the RC 14 drives the lighting load 16 from over-saturated lumen output region to a point where the lumen output saturation just gets started. No users should notice any lumen change since there is relatively no lumen change. Level 1 control occurs either automatically in the RC or by using the eco-mode button 22a or 22b. The Second level, which is selected by the user by using the eco-mode button on the RC or on a switch 12, further reduces the input power of the lighting load so that its lumen output is reduced about 1% to 20% compared with its maximum/saturated lumen output. The perceived light level change is not noticeable to the majority of the people as stated hereinabove.

The control provided can be either open-loop (see FIG. 3a) or closed-loop (see FIG. 3b). For the open-loop control, aka Level 1 control, the RC 14 knows the lighting load and its power and lumen output characteristics. A user can then input the type of load and its required wattage, which may have to be determined in a lab, and/or lumens using keypad (28) or may be preloaded in the RC. The RC adjusts the power (e.g. to the required wattage) sent to the known load 16 to minimize the oversaturation of the load to achieve concomitant savings. The control unit knows what power level it needs to apply to the lighting load to achieve Level 1 or Level 2 control. For the close-loop control (aka Level 2) shown in FIG. 3(b), the switch control unit may have no knowledge of the lighting load. The control unit relies on a lumen sensor to provide the lumen feedback to achieve Level 1 and Level 2 control by using the lumen sensor shown in the FIG. 3a. However additional savings are achievable. For instance, it is known that the standard listed lumen output for incandescent bulb are 25, 110, 200, 350, 500, 700, 800, 850, 1000, 1100, 1200, 1450, 1600, 1700, 2350, 2850, 3900, 6200, etc. Such information can be stored as a data table or the like or input through keypad 28. If such a bulb is switched on and it is emitting more than the stated lumen output, the RC will receive such information from the lumen sensor and automatically lower the power to the bulb until the promised lumen output is achieved and then exercise Level 1 control or Level 2 control as desired.

In one example the “eco-mode” control 22 a is operable to command the RC 14 to reduce an amount of power being transferred from power source 18 to the load 16 such that a power consumption of the load 16 is reduced by a first percentage and a luminance of the load 16 is reduced by a second percentage smaller than the first percentage. In one example the second percentage is within a range of 0-60% of the first percentage. This is possible because in some lighting systems a power reduction produces a corresponding lumen output reduction that is much less than the percentage of the power reduction.

Although a wireless lighting control system including wireless battery-less switches has been described above, it is understood that the economy mode describe above could be applied to wired lighting systems.

Although a preferred embodiment of this invention has been disclosed, a worker of ordinary skill in this art would recognize that certain modifications would come within the scope of this invention. For instance this system may be used to control other loads other than lighting loads where there is an oversaturation of power. For that reason, the following claims should be studied to determine the true scope and content of this invention.

1. A system for controlling a lighting load, such system comprising;
A controller for controlling an amount of power to said load,
An input to said controller, said input providing information as to an amount of excess power under which said load operates that is above a required amount of power whereby said controller lowers said amount of power provided to said load to minimize said amount of excess power.

2. The system of claim 1, such input further comprising;
Data as to the actual required power needed by a lighting load to provide lumens associated with said lighting load, whereby said controller provides said required power to said lighting load thereby reducing the power consumption of said load.

3. The system of claim 1, such input further comprising;
A lumen sensor for providing information as to the luminance of a lighting load, so that the controller can lower the power sent to said lighting load without effecting the luminance of said lighting load.

4. The system of claim 1 further comprising;
A second input that activates the system to reduce power to said load such that the controller reduces power below said required power to said load such that said load is dimmed to a first luminance.

5. The system of claim 4, wherein said second input further comprising;
An activator on said controller.

6. The system of claim 4, wherein said second input further comprising;
An activator on a remote switch.

7. The system of claim 4, wherein said second input further comprising;
Activation of said second input a second time, reduces the first luminence to a second luminance.

8. A system for controlling a lighting load, such system comprising;
A controller for controlling an amount of power to said load,
A lumen sensor for providing a first lumen input to said sensor from a load, whereby said controller receives lumen output information from said load and reduces power to said load until said first lumen output indicates that a change to a second lumen output has or is occurring, whereby said controller lowers said amount of power provided to said load to minimize said amount of excess power.

9. The system of claim 8, such system further comprising;
An input to said controller, said input providing data as to a typical amount of lumens associated with a given power input to a lighting load whereby the controller compares the amount of lumens received from said lumen sensor with said data to determine whether the lighting load lumen output is different from said typical amount of lumens and varies an amount of power provided said load to bring said lumen output to said typical lumen output.

10. A lighting system method for controlling lumens provided from a lighting load, said method comprising:
Providing a lumen sensor for determining a lumens output from said lighting load,
Reducing power to said load until said lumen output from said lighting load as sensed by said sensor drops or begins to drop, whereby excess power provided to said lighting load is minimized thereby saving power.

11. The method of claim 10 for controlling lumens provided from a lighting load, wherein said method further comprises:
raising said lumen output of said lighting load back to its initial lumen output if the load drops below its initial lumen output and the load is not dimmable.

12. The method of claim 10 for controlling lumens provided from a lighting load, wherein said method further comprises:
continuing to reduce power to said load and said initial luminance of said load, if said load is dimmable, by an amount that is not visibly detectable by a majority of viewers.

13. The method of claim 12 for controlling lumens provided from a lighting load, wherein said method further comprises:
reducing the first luminance by a predetermined amount to a second luminance, wherein the predetermined amount is reduced within a range of 1-20% of the first luminance.

14. The method of claim 13 for controlling lumens provided from a lighting load, wherein said method further comprises:
Selectively reverting to the first luminance.

15. The method of claim 10 for controlling lumens provided from a lighting load, wherein said method further comprises:
Selectively continuing to reduce power to said load and an initial luminance of said load, if said load is dimmable, by an amount that is not visibly detectable by a majority of viewers.

16. The method of claim 15 for controlling lumens provided from a lighting load, wherein said method further comprises:
Selectively reducing said initial luminance to a second luminance, wherein the second luminence is within a range of 80% -99% of said initial luminance.

17. The method of claim 16 for controlling lumens provided from a lighting load, wherein said method further comprises:
Selectively reverting to said initial luminance.

18. The method of claim 16 for controlling lumens provided from a lighting load, wherein said method further comprises:
Selectively reducing said second luminance to a third luminance that is 1-60% lower than the second luminance.

19. A method for controlling a lighting load, such method comprising;
Providing a controller for controlling an amount of power provided to said load,
Comparing a known power required by a load to produce a given lumen output with the actual power provided to said load, and
Lowering said actual power to said known power to minimize excess power delivered to said load.

20. A method for controlling a lighting load, such method comprising;
Providing a controller for controlling an amount of power provided to said load,
Comparing a lumen output produced by a load and a lowest known power to produce said lumen output with an actual power provided to said load, and
Lowering said actual power to said known power to minimize excess power delivered to said load.
